(19) United States
(12) Patent Application Publication
(10) Pub. No.: US 2007/0179650 A1
(43) Pub. Date: Aug. 2, 2007

(54) METHOD AND SYSTEM FOR ANALYZING STANDARD TOOL MESSAGES IN A MANUFACTURING ENVIRONMENT

(76) Inventors: Konrad Rosenbaum, Pima (DE); Jan Rothe, Dresden (DE)

Correspondence Address: WILLIAMS, MORGAN & AMERSON, 10333 RICHMOND, SUITE 1100, HOUSTON, TX, 77042, US

(21) Appl. No.: 11/548,445

(22) Filed: Oct. 11, 2006

(30) Foreign Application Priority Data
Jan. 31, 2006 (DE) 10 2006 004 408.8

(51) Int. Cl. G06F 19/00

(52) U.S. Cl. 700/96

(57) ABSTRACT

By analyzing process messages exchanged between one or more process tools and a remote host system, the status of the communication may be efficiently monitored. The analysis of the respective process messages may allow interpretation of process messages so as to have increased intelligibility, wherein additionally the process messages may be classified in accordance with one or more predefined criteria. Thus, the detection of even subtle communication inefficiencies may be significantly enhanced.

### BACKGROUND OF THE INVENTION

1. Field of the Invention

Generally, the present invention relates to the field of fabricating semiconductor devices, and, more particularly, to the monitoring of equipment required for processing different types of semiconductor devices with different process recipes.

2. Description of the Related Art

Today's global market forces manufacturers of mass products to offer high quality products at a low price. It is thus important to improve yield and process efficiency to minimize production costs. This holds especially true in the field of semiconductor fabrication, since, here, it is essential to combine cutting-edge technology with mass production techniques. It is, therefore, the goal of semiconductor manufacturers to reduce the consumption of raw materials and consumables while at the same time improve process tool utilization. The latter aspect is especially important since, in modern semiconductor facilities, equipment is required which is extremely cost-intensive and represents the dominant part of the total production costs.

Complex mass products, such as integrated circuits, micro-mechanical devices, opto-electronic devices and any combination thereof, are typically manufactured in automated or semi-automated facilities, thereby passing through a large number of process and metrology steps to complete the devices. The number and the type of process steps and metrology steps a product, e.g., a semiconductor device, has to go through depends on the specifics of the product to be fabricated. A usual process flow for an integrated circuit may include a plurality of photolithography steps to image a circuit pattern for a specific device layer into a resist layer, which is subsequently patterned to form a resist mask for further processes in structuring the device layer under consideration by, for example, etch or implant processes and the like. Thus, layer after layer, a plurality of process steps are performed based on a specific lithographic mask set for the various layers of the specified device. For instance, a sophisticated CPU requires several hundred process steps, each of which has to be carried out within specified process margins to meet the specifications for the device under consideration. Since many of these processes are very critical, a plurality of metrology steps have to be performed to efficiently control the process flow. Typical metrology processes may include the measurement of layer thickness, the determination of dimensions of critical features, such as the gate length of transistors, the measurement of dopant profiles and the like. As the majority of the process margins are device-specific, many of the metrology processes and the actual manufacturing processes are specifically designed for the device under consideration and require specific parameter settings at the adequate metrology and process tools.

In a semiconductor facility, a plurality of different product types are usually manufactured at the same time, such as memory chips of different design and storage capacity, CPUs of different design and operating speed and the like, wherein the number of different product types may even reach one hundred and more in production lines for manufacturing ASICs (application specific ICs). Since each of the different product types may require a specific process flow, different mask sets for the lithography and specific settings in the various process tools, such as deposition tools, etch tools, implantation tools, chemical mechanical polishing (CMP) tools and the like, may be necessary. Consequently, a plurality of different tool parameter settings and product types may be simultaneously encountered in a manufacturing environment.

Thus, a large number of different process recipes, even for the same type of process tools, may be required which have to be applied to the process tools at the time the corresponding product types are to be processed in the respective tools. However, the sequence of process recipes performed in process and metrology tools or in functionally combined equipment groups, as well as the recipes themselves, may have to be frequently altered due to fast product changes and highly variable processes involved in the fabrication of complex products, such as semiconductors and the like. Furthermore, new process tools may have to be implemented into the production environment, while other tools may have to be re-installed after maintenance events and the like. As a consequence, the overall equipment performance, for instance in terms of yield and throughput, is a very critical and complex manufacturing parameter as it significantly affects the overall production costs of the individual devices. The progression of tool yield and throughput over time of individual process and metrology tools or even certain entities thereof, such as process modules, substrate robot handlers, load ports and the like, may, however, remain unobserved due to the complexity of the manufacturing sequences, including a large number of product types and a corresponding large number of processes, which in turn are subjected to frequent recipe changes. Hence, low-performing tools may remain undetected for a long time when the performance of an equipment group which the tool under consideration belongs to is within its usual performance margin that typically has to be selected so as to allow a relatively wide span of variations owing to the complexity of the processes and the tools involved. Consequently, the individual reliability, availability and maintainability of the process tools has a significant influence on the overall yield and product quality.

For this reason, it is of great importance for the semiconductor manufacturer to monitor and determine corresponding metrics that provide a measure for the performance of individual process tools, thereby also enabling tool suppliers to specifically improve software and hardware components of process tools on the basis of the data provided by the manufacturers. Since tool requirements may significantly depend on manufacturer-specific conditions, a plurality of industrial standards have been defined to provide a foundation for defining a common global set of semiconductor equipment requirements, thereby reducing company-specific requirements for production equipment while, on the supplier side, attention may be focused on improving process capabilities instead of maintaining many customer-specific products. Thus, in some industrial fields, a plurality of equipment-specific standards have been defined relating to the definition of equipment messages, which, for the semiconductor industry, are known under SECS (SEMI (Semiconductor Equipment and Materials Institute) Equipment Communications Standard), which establish a common language for a communication between process tools and a remote host system. Similarly, a plurality of standards are established for defining the tool performance. For example, in the field of semiconductors, the E10 and E58 standards provide a basis to assess the reliability, availability and the maintainability (RAM) of process tools using standard tool states. Other standards, such as the E116 standard, have been introduced to describe the performance of process tools based on a state model, wherein the tool state is automatically reported by providing state transitions and run rate information.

Consequently, great efforts are made to establish standards for communicating and controlling the process flow within a complex manufacturing environment, such as a semiconductor facility, in a highly automated manner, wherein automated data gathering techniques are typically used due to the high number of process tools generating a correspondingly high amount of process information during a certain run time period. However, process tools have become more complex in that a process tool may include a plurality of functional modules or entities, such as complex load ports, substrate handling systems, the actual process chambers for performing process sequences or performing a plurality of processes in parallel, wherein so-called clusters or cluster tools are increasingly used, which may operate in a parallel and/or sequential manner such that a product arriving at the cluster tool may be operated therein in a plurality of process paths, depending on the process recipe and the current tool state. Thus, an immense amount of data may be created with respect to the operation of the manufacturing environment, since many of the processes in the tools are coordinated by a supervising control system in order to efficiently schedule the products and the operation of the process tools. Consequently, a very high number of process messages may be generated and exchanged between the remote host system and the process tools for each individual entity or process module. Thus, the overall performance of the manufacturing environment may depend significantly on the efficiency of the data communication in the environment.

For example, in semiconductor plants using production and measurement equipment configured for 300 mm substrates, a significant increase of process messages compared to 200 mm equipment is to be expected when a high degree of automation is desired, since most remote host systems, also referred to as MES (manufacturing execution system), for 300 mm production require nearly full compliance with the corresponding SEMI standards in order to provide enhanced functionality and controllability of the process tools. Thus, when establishing an efficient control strategy for the MES in order to improve yield and throughput, highly complex algorithms may be developed, the efficiency of which in turn depends on the effectiveness of the communication between the MES and the process tools. However, the immense amount of data exchanged between the process tools and the MES in the form of standard equipment messages may not be efficiently screened on the basis of conventional techniques.

In view of the situation described above, there is therefore a need for a technique that enhances the efficiency of a production process especially in view of tool performance related issues.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present invention relates to a method and a system for analyzing process messages communicated between a process tool and a remote host system, thereby significantly enhancing the efficiency of the supervising host system with respect to control efficiency, yield and throughput of a specific manufacturing environment for semiconductor devices. By means of analyzing the process messages, which are typically exchanged in a specified standard protocol, a high amount of process messages may be efficiently “screened” in order to evaluate the “status” of the communication within the manufacturing environment with respect to the supervising host system, thereby providing the potential for enhanced product yield and throughput by using a high degree of automation. The analyzed process messages may be used in some illustrative embodiments for the detection of a non-compliance of the actual communication with existing references and standards which may then give further guidance for searching for process inefficiencies in the manufacturing environment. Moreover, analyzing the process messages provides the basis for monitoring the data communication online in order to immediately respond to detected deviations, which may give valuable information on the grounds of process flow irregularities.

According to one illustrative embodiment of the present invention, a system comprises an interface configured to receive process messages in a standard format from a communications link between a host system and one or more process tools of a manufacturing environment. The system further comprises a process message analyzing unit connected to the interface and configured to interpret each of the process messages and classify each of the process messages according to at least one of a plurality of predefined selectable criteria.

According to another illustrative embodiment of the present invention, a method comprises receiving process messages from a communications link between a host system and one or more process tools of a manufacturing environment, wherein the process messages are exchanged in a standardized format. The method further comprises interpreting the process messages so as to have an increased degree of intelligibility for human perception compared to the non-interpreted process messages.

According to yet another illustrative embodiment, a method comprises receiving process messages from a communications link between a host system and one or more process tools of a manufacturing environment, wherein the process messages are exchanged in a standardized format. The method further comprises analyzing the process messages by classifying the process messages on the basis of one or more selectable criteria.

### BRIEF DESCRIPTION OF THE DRAWINGS

The invention may be understood by reference to the following description taken in conjunction with the accompanying drawings, in which like reference numerals identify like elements, and in which:

FIG. 1a schematically illustrates a manufacturing environment including a process message analyzing system according to illustrative embodiments of the present invention;

FIGS. 1b-1e schematically illustrate flowcharts of operational modes of a process message analyzing system of FIG. 1a l in accordance with illustrative embodiments;

FIGS. 1f-1g schematically illustrate the system of FIG. 1a with additional functionality in accordance with further illustrative embodiments;

FIG. 1h represents a flowchart for illustrating an operational mode according to the system as shown in FIG. 1g; and

FIG. 1i schematically illustrates the process message analyzing system with a statistical unit for determining statistical parameters of the process messages on the basis of true utilization.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i. e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present invention relates to the monitoring and, in some embodiments, to the controlling of the communication established in highly complex semiconductor-related manufacturing environments involving one or more process tools that are operated at least partially on the basis of process messages including instructions and the like provided by a remote host system, such as a manufacturing execution system (MES). As previously explained, highly complex manufacturing environments, such as semiconductor plants and the like, are operated in a highly automated fashion, wherein the host system may coordinate the overall process flow within the manufacturing environment. That is, the host system may be connected to each of the process tools in order to obtain respective process messages therefrom, from which relevant information with respect to the status of the manufacturing environment may be extracted. For example, in order to allow an efficient process flow through the manufacturing environment, products at various manufacturing stages have to be supplied to respective process tools, wherein simultaneously the required raw materials and process recipes are to be available at the respective process tools. Due to the highly complex process flow requiring the organization of a plurality of different product types in a plurality of highly complex process tools, as is explained above, data communication between the host system and the process tools may be vital for efficient operation of the manufacturing environment. Consequently, appropriate hardware and software standards are typically encountered, for instance in the form of the SEMI standards, in order to provide enhanced tool compatibility and increased flexibility for developing control strategies.

Although control mechanisms for operating specific process tools and process tool groups have been established and currently used host systems provide a high degree of process flow and material flow control functionality, the “status” of the communication itself, e.g., the degree of compliance of process messages exchanged between the process tools and the remote host system, currently may not be efficiently determined. Since the communication status may, however, significantly influence the status of the control efficiency of the remote host system and thus to a certain degree the yield and throughput obtained in the manufacturing environment, especially during installation or re-installation of parts or all of the manufacturing environment, the present invention is directed to techniques that may enable an enhanced evaluation of the communication status by automatically analyzing the process messages, wherein, in some illustrative embodiments, the process message analysis may be performed online, i.e., during the operation of the process tools under the control of the remote host system, or, in other embodiments, additionally or alternatively, after the completion of a specific production run or test run. By analyzing the process messages even very subtle discrepancies of the communication sequence with an expected sequence may be detected and may yield valuable information as to the rectification of such discrepancies or other irregularities in the manufacturing environment.

The analysis of process messages may be accomplished, in some embodiments, on the basis of a classification of these messages in accordance with predefined and selectable criteria, thereby providing the potential for searching for communication inefficiencies in a highly efficient manner. In still other illustrative embodiments, additionally or alternatively, the analysis of process messages may be accomplished by interpreting the corresponding standardized process messages in order to significantly increase their intelligibility with respect to human perception so that the process messages after interpretation may be “screened” by operators in a highly efficient fashion compared to the screening of the standardized process messages, as may be provided by typical log files of the host system. It should be appreciated that the present invention is highly advantageous in the context of semiconductor production, since here a high data traffic between the remote host system and the process tools may be required, wherein it should be appreciated that the term “semiconductor” is to be understood as a generic term for any microstructural devices involving the formation of structural features on the basis of micromechanical or microelectronic techniques.

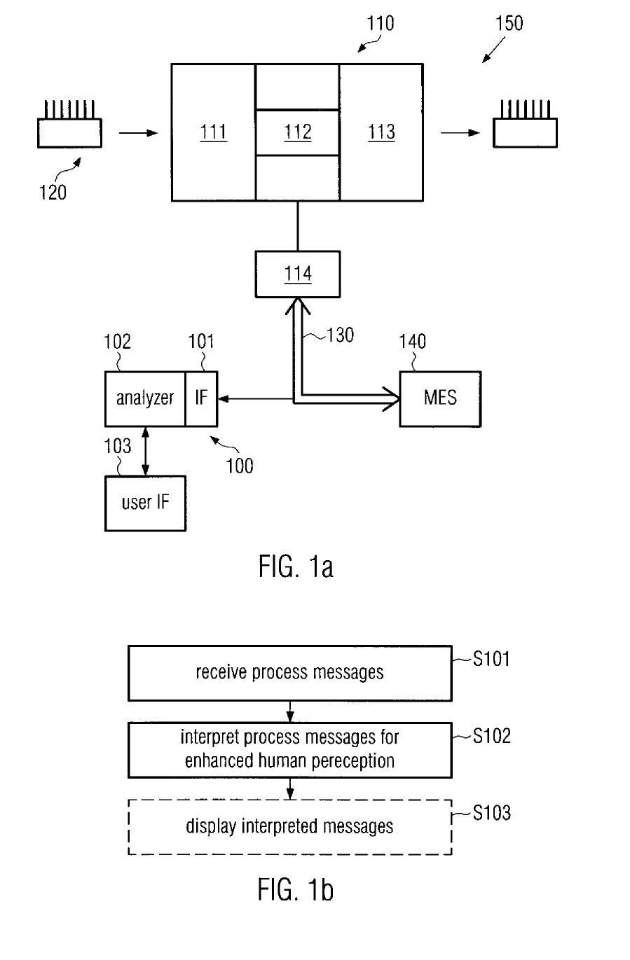

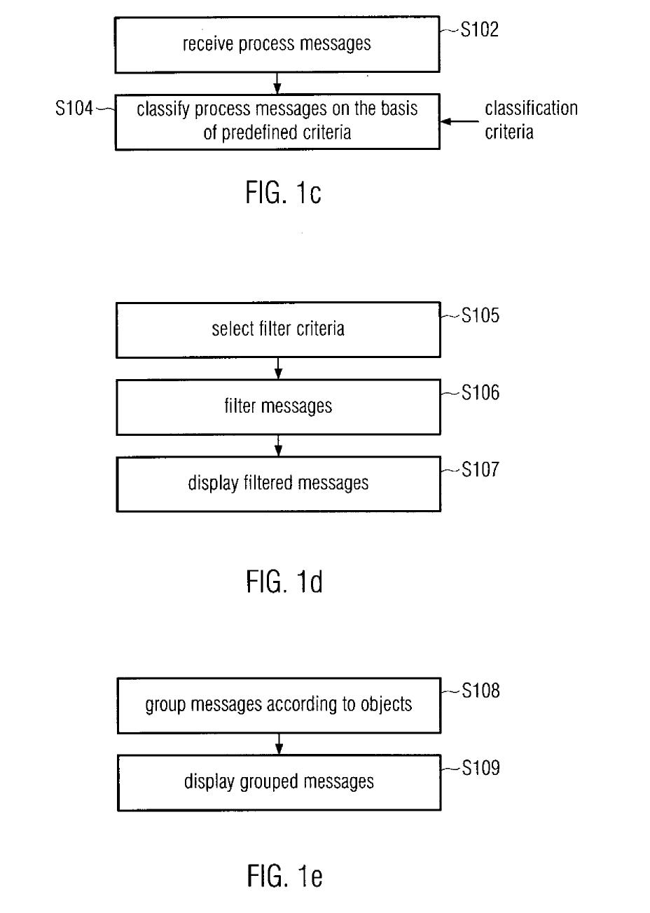

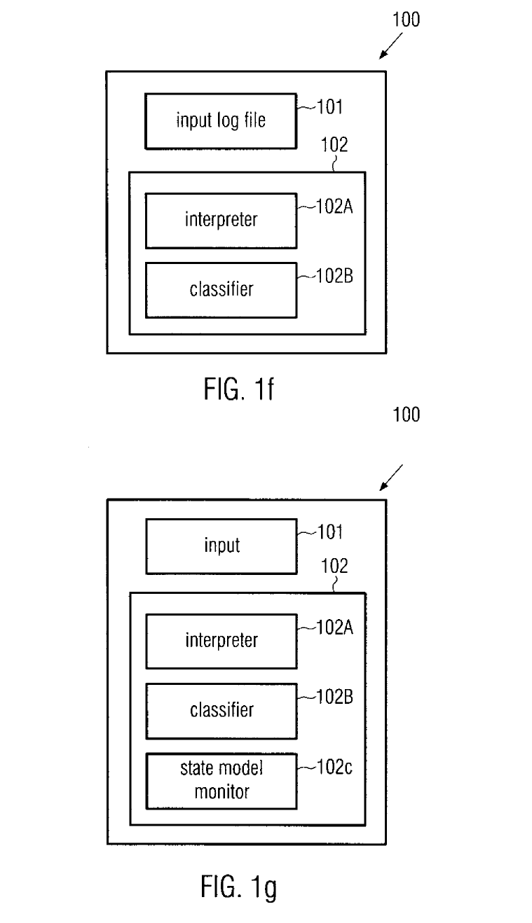

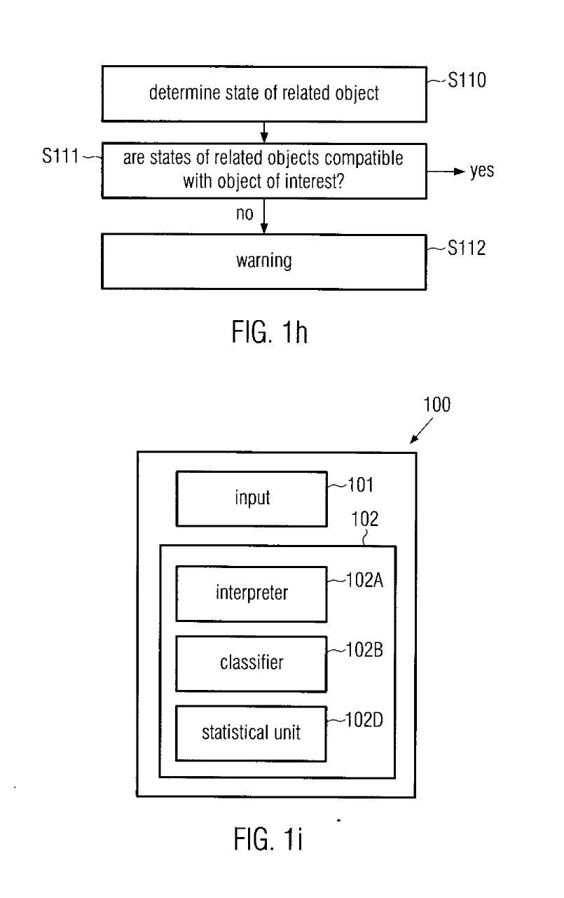

With reference to FIGS. 1a-1i, further illustrative embodiments of the present invention will now be described in more detail. FIG. 1a schematically shows a manufacturing environment 150 which, in one illustrative embodiment, represents an environment for the fabrication of semiconductor devices. The environment 150 may comprise a plurality of process tools 110, from which only one is illustrated for convenience. The term “process tool” is meant to include any metrology tool, such as inspection tools, measurement tools for gathering electrical data, actual production tools and the like, as are typically used for the processing of products 120, such as substrates having formed thereon microstructural devices and the like. For instance, the process tool 110 may represent a lithography station, which may in turn comprise one or more lithography tools, one or more development stations, one or more resist coating stations and other pre- and post-exposure treatment stations.

Prior to and after the process tool 110, other process tools are typically provided for processing the substrates 120 in accordance with a specified process flow. As may be appreciated, each process performed in the process tool 110 may be highly complex and may require sophisticated process control mechanisms in order to provide a device at the output of the process tool 110 that is within specified process margins. Due to the complexity of the process tool 110, it may be in a plurality of different process states and may also exhibit a certain status with respect to its hardware configuration, for instance in terms of the status of consumables, availability of raw materials and the like. The process tool 110 typically comprises a plurality of components, which may also be referred to as entities and which may represent process modules or process chambers, substrate handling robots, load ports and the like. For instance, the tool 110 may comprise a port 111 for loading a substrate and a port 113 for unloading the substrate after processing and may also comprise one or more process modules 112. It should be appreciated that each of the entities of the tool 110 may itself be comprised of one or more sub-entities, wherein an entity may generally be considered as a part of the process tool whose activity may be controlled and monitored on an individual basis. For instance, a process tool may have a substrate load port including a robot handling device including a plurality of peripheral components for the proper operation of the load port, wherein no external access to these peripheral components may be provided. In this case, the load port may be considered as an individual basic entity of the tool 110, since its process status may be observed via process messages, indicating for instance when the load port is processing or is in an idle mode or is blocked. Similarly, the status of any other entity within the process tool 110, such as the entities 112 and 113, may be communicated via corresponding process messages and may also be controlled to a certain degree via received process messages. For this purpose, the process tool 110 may comprise an interface 114, which is configured to enable communication with a supervising host system, an operator or other process tools and peripheral components.

In the embodiment shown, the manufacturing environment 150 comprises a manufacturing execution system (MES) 140, which is typically provided in semiconductor production facilities to manage resources, raw materials, process tools and process recipes during the coordination of the various process flows within the manufacturing environment 150. Consequently, the manufacturing execution system 140 may be configured to receive tool-specific information from the process tool 110 in the form of appropriately formatted process messages via the interface 114 and may, in response to process requirements and/or in response to tool-specific information obtained, issue corresponding instructions in the form of process messages to the process tool 1 10. The communication between the process tool 110 and the MES 140 may be established by means of a communications link 130 that is configured to provide the required hardware and software resources for transmitting the process messages in one or more specified formats with the required speed.

As previously explained, in the semiconductor industry, a plurality of standards are typically used for coordinating the cooperation of the various process tools 110 and the host system 140. Some representative SEMI standards, i.e., software standards for factory automation in the semiconductor industry, may be the E5, E40, E84, E87, E90 and E94 standards. For instance, the E5 standard (SECS-II) represents a message protocol that is used by all the SEMI software standards. Messages according to the E5 standard may be communicated on the basis of standardized communication links. For instance, the communications link 130 provided between the interface 114 and the system 140 may, in one illustrative embodiment, be configured to enable data traffic according to the E5 standard. The E84 standard relates to an enhanced parallel interface for cassette transfer and specifies hardware configuration for substrate cassettes according to automated material handling systems. The E87 standard relates to a carrier management system and defines standards for substrate carrier transfer and provides standardized behavior of the communication between the system 140 and the tool 110. The E90 standard specifies standards and services for checking a substrate within the tool 110. The E40 standard is defined to manage a process job and allows automated control of material processing in the environment 150. Similarly, the E94 specification relates to the control job management and specifies, for example, the material arrival at the tool 110 and the invocation of an appropriate process job. Thus, in some illustrative embodiments, the environment 150 may operate on the basis of at least some of the above-identified standards, thereby exchanging process messages over the communications link 130 on the basis of predefined standards.

The manufacturing environment 150 further comprises an analyzing system 100 that is configured for analyzing standardized process messages transferred via the communications link 130. The system 100 may comprise an interface 101 that is adapted to be connected to the communications link 130 in order to receive therefrom a plurality of process messages exchanged between the tool 110 and the system 140. It should be appreciated that a connection between the communications link 130 and the interface 101 may be established, temporarily or permanently, depending on requirements. For instance, the interface 101 may be configured to receive the plurality of process messages on the basis of one or more so-called log files, which may have stored therein, in timed sequence, the process messages exchanged between the tool 110 and the system 140 for a specified time period. In other illustrative embodiments, additionally or alternatively, the interface 101 may be configured to obtain any process messages communicated via the link 130 in a substantially real-time manner, thereby providing the potential for performing an online analysis of the process messages exchanged between the process tool 110 and the MES 140 during run time.

The system 100 further comprises a process message analyzing unit 102 connected to the interface 101, wherein the analyzing unit 102 may, in one illustrative embodiment, be configured to interpret received process messages such that the intelligibility of the interpreted process messages with respect to human perception is higher than the corresponding intelligibility of the non-interpreted process messages. That is, typically, the process messages may be comprised of alpha-numeric symbols in accordance with a specified communications protocol, when displayed in any appropriate display unit. Based on these initial process messages, the analyzing unit 102 may operate on the respective process messages in order to provide additional information, thereby significantly increasing the “readability” of the interpreted process messages when displayed in an appropriate device, such as a user interface 103. For example, in some illustrative embodiments, the analyzing unit 102 is configured to operate on the process messages such that each of the process messages is related to a data set that, when provided to the user, significantly enhances readability by providing additional information, for instance in the form of readable text and the like, in order to explain at least some aspects of the related process message. Thus, increasing the intelligibility for human perception is to be understood so that the received process messages are interpreted by associating each message with additional semantic and/or graphical information that may be presented alone or in combination with the contents of the initial process message, thereby significantly facilitating the further evaluation of the process message by an operator. In other illustrative embodiments, the analyzing unit 102 is additionally or alternatively, configured to classify the process messages in accordance with one or more selectable criteria, as will be described in more detail later on.

During operation, the system 140 may set up the process tool 110 in accordance with a specified type of products 120 to be processed such that the tool 110 is configured to carry out a specific process recipe for the substrates 120 arriving at the tool in accordance with a specified schedule. During this process, corresponding process messages may be generated by the tool 110 and the system 140 and may be communicated via the interface 114 and the communications link 130 according to a predefined control sequence. For example, in the field of semiconductor industry, the process tools 110 are to a high degree standardized in such a form that the respective entities, such as the entities 111, 112, 113 and the like, may be described in the form of respective state models in order to obtain a high degree of flexibility for communicating and controlling the respective process tools. For example, each of the entities 111, 112 and 113 may be defined as a software object representing a state model implying several state transition events, a state variable, an object identifier plus some other attributes, depending on the object type. Moreover, additional events and commands may be associated with the respective object. Thus, the state of each of the entities 111, 112 and 113 may be reported on the basis of the respective state of the state model by means of a standardized process message, wherein, in response, if required, the system 140, after identifying the process message, may create a corresponding process message, which may, for instance, indicate a command such as to initiate an event in one of the entities 111, 112, 113, such as a state transition. Due to the complexity of the tool 110 and the processes performed therein, a large number of process messages regarding the type of substrates, their location within a respective carrier, the status and activities of the load ports, the status and activities of substrate handling entities responsible for substrate transportation within the tool and the like are typically exchanged. Conventionally, the process messages are stored within the system 140 in the same order as they are created and exchanged. In one illustrative embodiment of the present invention, the corresponding process messages may be analyzed by the system 100 at any appropriate point in time by providing the corresponding stored data to the interface 101, which may be accomplished by providing the interface 101 with a log file for a completed production or test run, or by providing a specified block of process messages or by providing the messages representing a specified run time of the tool 110.

FIG. 1b schematically illustrates a flowchart that illustrates the processing of the respective process messages according to one illustrative embodiment. In step S101, the interface 101 receives the process messages, which in one illustrative embodiment may be accomplished by means of a file-based database system, in which all messages and analysis information may be stored. For example, the corresponding process messages in the system 140 may be transferred to a corresponding database on which the unit 102 may then operate in order to analyze the process messages. The process messages may be obtained from any appropriate system and in any appropriate format as is used in the system 140 for storing the corresponding data. In step S102, the process messages are interpreted, according to one illustrative embodiment, in order to enhance the intelligibility for human perception when presenting the interpreted process messages to an operator, for instance, by means of the user interface 103. In some illustrative embodiments, one or more interpreted messages may be selected, for instance by user interaction with the user interface 103, in order to further evaluate the process message, wherein the corresponding association with additional information, such as text and/or graphics for explaining or otherwise supplementing the initial process message significantly enhances the readability of the corresponding process message. That is, in some illustrative embodiments, the meaning of numbers and letters in the message is more clearly represented by using appropriate additional information, such as written language, icons, usage of different colors and the like. Thus, in some illustrative embodiments, in step S103, the corresponding interpreted messages may be displayed to a user with enhanced intelligibility compared to the non-interpreted messages.

FIG. 1c schematically illustrates the operation of the system 100 in accordance with further illustrative embodiments, wherein, in addition to or alternatively to the step S102 for interpreting the process messages so as to have an enhanced intelligibility for human perception, the process messages are classified on the basis of one or more selectable criteria. In some illustrative embodiments, the one or more selectable criteria may comprise some aspects of the tool behavior, such as analyzing the received process messages and classifying them with respect to messages relating to the processing state of the process tool 110, messages relating to substrate movement within the tool 110, messages relating to the carrier status, i.e., to the arrival, the carrier identification in which the substrate 120 is conveyed, the carrier slot map verification, i.e., scanning of the various substrate slots with respect to substrates actually placed therein, and the like, and process messages relating to the hardware status of the tool 110. Consequently, by classifying the respective process messages, they may be efficiently “screened” with respect to certain process tool inefficiencies since the respective involved process messages may be provided in a sorted manner classified according to selectable sort criteria, contrary to conventional log files in which the respective process messages are in a timed sequence.

In other illustrative embodiments, the classification may be implemented in the form of message filters, as is for instance schematically shown in the flowchart of FIG. 1d. In FIG. 1d, in step S105, one or more filter criteria may be selected, for instance by interaction with the user interface 103, wherein, in some illustrative embodiments, the basic filters in the analyzing unit 102 may be divided into header level filters and message level filters. Header level filters may operate on messages based on their header content, such as direction, stream/function and control bit. Message level filters may operate on messages based on communication-specific data items, for instance for the SECS-II standard, items such as CEID, RPTID and the like. For example, in some illustrative embodiments, the selection of one or more filter criteria in step S105 may be performed by means of the user interface 103 by appropriately selecting one or more criteria related to the message header. For example, the direction used as criterion may be selected between “receive” and “transmit.” Similarly, for stream/function, any appropriate values may be selected, wherein an appropriate filter action may then also be selected on the basis of one or more predefined filter actions. Similarly, one or more items of the respective message filter may be selected and one or more items to which a comparison is to be performed may also be selected, for instance by using the user interface 103. Again the filter action may be selected as before. Thus, in step S106, the corresponding filter action is applied to the process messages and, in step S107, the filter action may be indicated, for instance, the filtered process messages may be displayed in the user interface 103. In other illustrative embodiments, an object level filter may be provided in which process messages may be filtered on the basis of a certain object type, i.e., on the basis of a certain class of entities, such as carriers used for conveying the substrate 120 within the environment 150, or the messages may be filtered with respect to a specific representative of the object type, i.e., a specific instance of an object type. That is, the filter process may be performed for a specific one of the carriers or other entities within the environment 150. Consequently, the classification of the process messages based on a filtering concept provides significantly enhanced intelligibility for an efficient evaluation of the process messages, even if a large number of corresponding messages is to be analyzed.

FIG. 1e schematically illustrates a flowchart in accordance with another illustrative embodiment, in which the process messages may be grouped according to objects, i.e., with respect to the respective state models representing the various entities 111, 112 and 113 of the tool 110, which “exist” in the (virtual) tool 110 at the time of the communication, which is reflected by the corresponding process messages to be analyzed. For example, the objects “carrier,” “load port,” “substrate” and the like may be present, i.e., the corresponding state models are active, in a process sequence, in which actually one of the substrates 120 is processed in the tool 110 under the control of the system 140, and hence a plurality of process messages are related to one or more of these objects. Thus, in step S108, the corresponding messages are classified according to the objects they are related to and may, in step S109, be displayed as message groups or blocks. Moreover, in some illustrative embodiments, providing the appropriately grouped messages may be combined with additional information in order to indicate the compliance of state models with respect to a predicted or standard or expected behavior. For example, for each message group belonging to a specified object or state model type, a certain degree of compliance, such as “no problem,” “minor problem,”“severe state model violation” and the like, may be provided in order to efficiently indicate the communication status for the various objects. Furthermore, the grouped messages may be displayed as interpreted messages, thereby significantly enhancing the readability of the corresponding messages, as is also described above.

FIG. 1f schematically depicts the system 100 according to one illustrative embodiment, in which the above-described functionality of classification and interpretation of process messages may be implemented. For this purpose, the system 100 comprises the analyzing unit 102 including an interpreting unit 102A and a classification unit 102B, which may be connected to the interface 101 for receiving the process messages, wherein, as previously described, in some embodiments, the unit 102B may cooperate with the unit 102A such that the classified messages may be presented as interpreted messages.

FIG. 1g schematically illustrates the system 100 in accordance with other illustrative embodiments, in which, in addition to an interpreter unit 102A and a classifier unit 102B, a state model monitor 102C may be provided. The state model monitor 102C may be configured to track the respective “evolution” of the various state models, i.e., the corresponding instances of the various object types, that are active during the time period of the communication between the tool 110 and the system 140 determined by the respective process messages. In one illustrative embodiment, the state model monitor 102C may be implemented in the form of respective objects, which are instantiated on the basis of respective process messages as to reflect the corresponding operational behavior of the tool 110 in response to the control messages of the system 140. The corresponding objects implemented in the state model monitor 102C may therefore allow tracking of all identified object instances and their history throughout the plurality of process messages to be analyzed, wherein, in some illustrative embodiments, the respective objects in the state model monitor 102C may have implemented therein additional features for providing interpreted messages with respect to the identified object instances, while, in other embodiments, a link between objects may be established that are in connection during run time. For example, during the evaluation of the process messages, each object in the state model monitor 102C may check certain attributes or links to other objects, such as carrier contents objects with respect to substrate objects. That is, a link may be established for an object representing substrate contained in a specific carrier position when the respective substrate, represented by the respective process messages related thereto, is present in the respective carrier position at the time of production. In other illustrative embodiments, the state model monitor 102C may be configured to estimate the compliance of the state models involved by performing cross-checks with the states of related objects, as is described with reference to FIG. 1h.

FIG. 1h schematically illustrates a respective flowchart of an exemplary operational mode for cross-checking an object state with respect to related states of objects. In step S110, a process message indicating a specific transition of an object of interest, for instance a carrier object, may be evaluated with respect to its relation to other objects. That is, for various state transitions in the respective state model or object, functionally related state models or objects representing, for instance, one of the entities 111, 112 and 113 of the tool 110 may be identified as state models having one or more states that are correlated with the state of the state model of interest. For instance, if a substrate is provided by a carrier to the load port 111 and is handled to be placed in the process chamber 112, the substrate object, i.e., state model, is correlated with the carrier object, and a certain state of the substrate object requires the carrier object to be in a certain state. Consequently, in step S110, the state model monitor 102C may identify one or more objects related to an object of interest on the basis of predefined correlations that may have been implemented during the implementation of the respective object types in the monitor 102C. In step S111, respective states of the related object or objects and of the object of interest may be tested with respect to compatibility with a standard or expected behavior, which in some embodiments may include the assessment of the degree of deviation from the expected behavior. Consequently, when a specified degree of deviation is determined, the respective states may be indicated as non-compatible states and in some illustrative embodiments, in step SI 12, a respective indication of non-compatibility may be assigned to the process message related to the object of interest. Thus, as previously described with reference to the classification by grouping process messages according to state models or objects, a degree of non-compatibility may be indicated by any appropriate means, such as a difference in color when displaying respective process messages on a screen and the like.

FIG. 1i schematically illustrates the system 100 in accordance with yet another illustrative embodiment, in which the analyzing unit 102 may comprise, in addition to the interpreter section 102A and the classifier section 102B, an analysis unit 102D, which may be configured to operate on the classified process messages to perform additional analysis on already completely grouped process messages independent from any initial interpretation and grouping. For example, the analysis performed by the unit 102D may comprise the additional checking of state models, statistical calculations, the determination of contiguity/correlation of different state models and the like. In one illustrative embodiment, the analysis unit 102D may be provided as a statistical unit, which may be configured to determine at least one statistical parameter in relation to process-specific aspects, such as the tool utilization of the tool 110. That is, in this illustrative embodiment, the statistical unit 102D may determine the amount of tool activities of the tool 110 on the basis of the received process messages and may determine the significance of certain communication related aspects, such as the occurrence of specific states in the state models with respect to workload or, when the system 100 also comprises the state model monitor 102C, the amount of state model violations, i.e., incompatibilities of states and the like. Consequently, the status of the communication between the system 140 and the tool 110 may be evaluated on the basis of load-specific aspects, thereby providing enhanced safety with respect to future process situations in the environment 150.

During operation of the analysis unit 102D to perform an additional analysis on the classified process messages, the configuration of the analysis unit 102D may be configured by a user or another external source, such as the MES 140, wherein a user configuration of the unit may be accomplished, for instance, by means of the user interface 101. Moreover, interaction with and thus modification of the analysis unit 102D may be accomplished in advance and/or during run time of the unit. Moreover, in some embodiments, the results or any other information relating to the analysis performed by the unit 102D may be presented to an external source, such as a user, for instance via the user interface, and/or to the MES 140.

As a result, the present invention provides an enhanced technique in which the communication between a host system and one or more process tools in a specified manufacturing environment may be efficiently monitored by analyzing the respective process messages exchanged between the tools and the host system. For this purpose, the process messages may be correlated with additional information in order to interpret the respective messages, thereby significantly increasing the intelligibility of the corresponding process messages, which may significantly improve the evaluation of the communication status, even when performed by an operator. Additionally, in some illustrative embodiments, the process messages may be classified according to a variety of criteria, which may be selected in advance or may be selected by a user, thereby significantly improving the visibility, when classifying substantially refers to filtering the process messages, and/or providing enhanced monitoring of state models, when the classifying is based on state models. Thus, in some illustrative embodiments, the compliance of the operational behavior of the process tool and the system may be estimated by comparing the respective process messages indicating states of state models with appropriate reference states, wherein an indication of the degree of state models violation may be obtained. Consequently, the analysis of the process messages according to the present invention provides a powerful means for estimating the status of the communication between process tools and a host system even on the basis of a manual assessment of the results provided by process message analyzing systems, thereby significantly reducing the time required for implementing appropriate control scenarios in a manufacturing environment. In still other illustrative embodiments, respective analyzing “threads” may be predefined and may be performed automatically, for instance by searching for state model violations when estimating the status of the communication in a substantially real-time manner. In this way, even a highly complex manufacturing environment involving a plurality of complex process tools may be monitored with respect to inefficiencies of the operation of the tools and/or the control sequence and/or the communication which may provide the potential for significantly reducing installation time and/or improving throughput and yield of the respective environment. The automated analysis of the process messages may in some illustrative embodiments be used in combination with control mechanisms for the manufacturing environment, for instance by activating appropriate control actions upon the detection of a state model non-compliance in an automated fashion, wherein the control actions may involve the process flow and/or the communication per se. That is, the analyzed process messages may be evaluated by, for instance, statistical techniques as is described above, thereby associating certain communication statuses with certain process situations. By detecting a respective status of the communication, respective measures, such as reducing tool utilization, re-scheduling substrates and the like, may then be initiated in order to re-adjust the communication status and thus the process situation. Corresponding mechanisms may be implemented in the system 100 and/or the MES 140 in order to provide an automated response to undesired process situations.

Consequently, by analyzing process messages exchanged between one or more process tools and a remote host system, the status of the communication may be efficiently monitored. The analysis of the respective process messages may allow interpretation of process messages so as to have increased intelligibility, wherein additionally the process messages may be classified in accordance with one or more predefined criteria. Thus, the detection of even subtle communication inefficiencies may be significantly enhanced.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A system, comprising:
an interface configured to receive process messages in a standard format from a communication link between a host system and one or more process tools of a manufacturing environment; and
a process message analyzing unit connected to said interface and configured to interpret each of said process messages and classify said process messages according to at least one of a plurality of predefined selectable criteria.

2. The system of claim 1, further comprising a user interface configured to select one or more of said predefined selectable criteria by user interaction.

3. The system of claim 2, wherein said user interface is further configured to display said interpreted process messages, and wherein a degree of intelligibility for human perception of said interpreted process messages is higher than a degree of intelligibility of said process messages in said standard format.

4. The system of claim 2, wherein said analyzing unit is connected to said user interface to enable configuration by a user.

5. The system of claim 1, wherein said process message analyzing unit is configured to interpret and classify each of a plurality of run-specific process messages of a specified process run during execution of said run-specific process messages by said one or more process tools.

6. The system of claim 5, wherein said process message analyzing unit is further configured to interpret and classify each of said plurality of run-specific process messages of said specified process run after completion of said specific process run.

7. The system of claim 1, wherein one of said plurality of selectable criteria represents a tool characteristic of at least one of said one or more process tools.

8. The system of claim 7, wherein said tool characteristic represents at least one of a processing state, a substrate transport in said one or more process tools, a carrier state in said one or more process tools and a hardware status.

9. The system of claim 8, wherein said process message analyzing unit further comprises a state model monitor unit configured to monitor one or more state models implemented in said one or more process tools.

10. The system of claim 9, wherein said state model monitor unit is further configured to identify one or more state models related to a monitored one of said one or more state models.

11. The system of claim 10, wherein said state model monitor unit is further configured to evaluate said monitored state model on the basis of a state of said one or more related state models.

12. The system of claim 9, wherein said state model monitor unit is further configured to evaluate said monitored state model on the basis of state transitions of said state model.

13. The system of claim 1, further comprising an analysis unit configured to operate on said classified process messages to perform at least one of a state model check, a statistical calculation and a contiguity determination for two or more state models.

14. The system of claim 13, wherein said analysis unit comprises a statistical analysis unit configured to determine a statistical characteristic of said process messages on the basis of tool utilization of said one or more process tools.

15. The system of claim 13, wherein said analysis unit is connected to said user interface to enable configuration by a user.

16. The system of claim 15, wherein said user interface is further configured to display one or more results generated by said analysis unit.

17. The system of claim 13, further comprising an interface configured to enable interaction with said analysis unit during run time of said analysis unit.

18. A method, comprising:
receiving process messages from a communication link between a host system and one or more process tools of a manufacturing environment, said process messages being exchanged in a standardized format; and
interpreting said process messages to have an increased degree of intelligibility for human perception compared to said process messages.

19. The method of claim 18, further comprising classifying said received process messages according to one or more predefined selectable criteria.

20. The method of claim 19, wherein classifying said process messages comprises filtering said process messages on the basis of selectable filter parameters.

21. The method of claim 20, wherein said filter parameters relate to at least one of a processing state of said one or more process tools, a substrate transport activity in said one or more process tools, a carrier status in said one or more process tools and a hardware status of said one or more process tools.

22. The method of claim 19, wherein classifying said process messages comprises grouping said process messages according to state models representing said one or more process tools.

23. The method of claim 22, further comprising operating on said classified process messages to perform a secondary analysis on said classified process messages.

24. The method of claim 23, wherein operating on said classified process messages comprises performing at least one of a state model check, a statistical calculation and a contiguity determination for two or more state models.

25. The method of claim 23, wherein operating on said classified process messages to perform said secondary analysis is user configurable.

26. The method of claim 23, wherein operating on said classified process messages comprises interactively entering information for controlling said operating while operating on said process messages.

27. The method of claim 23, further comprising displaying one or more results of said operating on the classified process messages.

28. The method of claim 22, further comprising evaluating one or more of said state models with respect to compliance with a predefined state model evolution.

29. The method of claim 28, wherein evaluating said one or more state models comprises identifying at least one reference state model related to said one or more state models to be evaluated and determining whether or not a state of said at least one reference state model is compatible with said one or more state models to be evaluated.

30. The method of claim 29, further comprising providing an indication of a result of said determination at least when said at least one reference state model and said one or more state models to be evaluated are not compatible.

31. The method of claim 18, further comprising determining at least one statistical parameter of said process messages on the basis of a degree of utilization of said one or more process tools.

32. A method, comprising:
receiving process messages from a communication link between a host system and one or more process tools of a manufacturing environment, said process messages being exchanged in a standardized format; and
analyzing said process messages by classifying said process messages on the basis of one or more selectable criteria.

33. The method of claim 32, wherein classifying said process messages comprises grouping said process messages according to state models representing the operation of said one or more process tools in said manufacturing environment under the control of said host system.

34. The method of claim 33, further comprising monitoring at least one of said state models with respect to a predefined operational behavior.

35. The method of claim 34, wherein monitoring said at least one state model comprises determining a compatibility of a state of interest of said at least one state model with a state of a state model correlated to said at least one state model when in said state of interest.

36. The method of claim 32, further comprising performing a statistical analysis of said process messages with respect to tool utilization of said one or more process tools.
